(19) United States
(12) Patent Application Publication
(10) Pub. No.: US 2010/0061092 A1
(43) Pub. Date: Mar. 11, 2010

(54) LED LAMP

(75) Inventors: RI-LANG YANG, Shenzhen City (CN); GUANG YU, Shenzhen City (CN); CHENG-TIEN LAI, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/206,738

(22) Filed: Sep. 9, 2008

(51) Int. Cl. F21V 33/00

(52) U.S. Cl. 362/234

(57) ABSTRACT

An LED lamp includes an LED module, a heat sink having a base to which the LED module is mounted, a plurality of screws extending through the LED module and into the base of the heat sink to secure the LED module on the base of the heat sink, and a plurality of elastic members mounted on the screws and positioned between the base and the LED module. The elastic members are expanded by the screws to generate a force engaging with the screws to thereby combine the screws and the LED module together beforehand.

### BACKGROUND OF THE INVENTION

1. Field of the Invention

The present invention relates to an LED lamp, and particularly to an LED lamp having an LED module preassembled with a mounting device for readily securing the LED module to a heat sink of the LED lamp.

2. Description of Related Art

An LED lamp is a type of solid-state lighting device that utilizes light-emitting diodes (LEDs) as a source of illumination. The LED has an advantage that it is resistant to shock, and has an almost eternal lifetime under a specific condition; thus, the LED lamp is intended to be a cost-effective yet high quality replacement for incandescent and fluorescent lamps. Conventionally, the LED lamp has a heat sink to dissipate heat generated by the LED module. The LED module is secured on the heat sink directly by a mounting device such as a plurality of screws. The assembly of the plurality of the screws are of some difficulties since the screws may drop from the LED module during the assembly. The problem is more serious when the assembly and disassembly of the LED lamp is operated outdoors and at a high level, which is occurred when the LED lamp is, for example, a highway lamp.

What is needed, therefore, is an improved LED lamp which can overcome the described disadvantages.

### SUMMARY OF THE INVENTION

An LED lamp includes an LED module, a heat sink having a base to which the LED module is mounted, a plurality of screws extending through the LED module into the base of the heat sink to secure the LED module on the base of the heat sink, and a plurality of elastic members mounted on the screws and positioned between the base and the LED module. The elastic members are elastically expanded to generate a force to combine the screws and the LED module together. The LED module, the screws and the elastic members are pre-assembled together before the LED module is secured to the base of the heat sink.

Other advantages and novel features will become more apparent from the following detailed description of preferred embodiments when taken in conjunction with the accompanying drawings.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric, exploded view of an LED lamp in accordance with a preferred embodiment of the present invention.

FIG. 2 is an assembled view of the LED lamp in FIG. 1.

FIG. 3 is a cross-sectional view of the LED lamp in FIG. 1.

FIG. 4 is a view similar to FIG. 3, but shows the LED module and the screws being combined together by the elastic members.

FIG. 5 is a cross-sectional view taken along line V-V of FIG. 2.

### DETAILED DESCRIPTION OF THE INVENTION

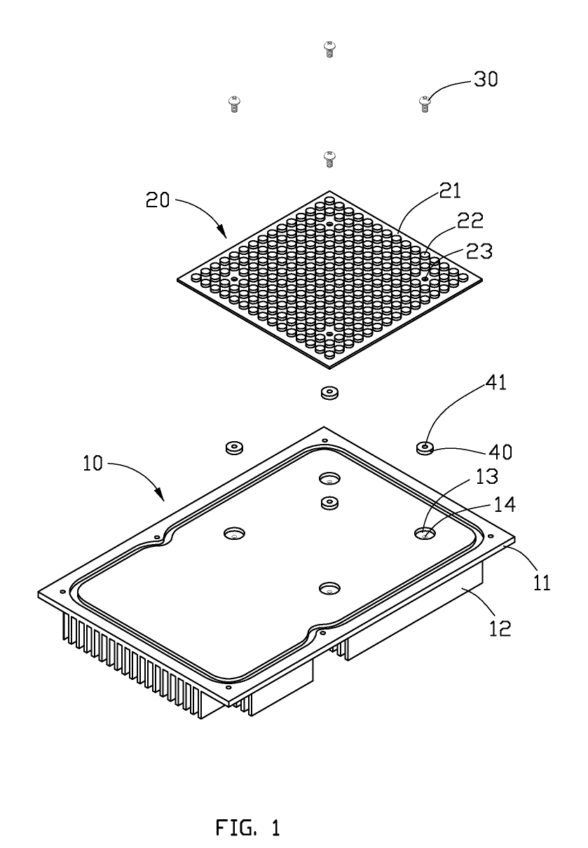

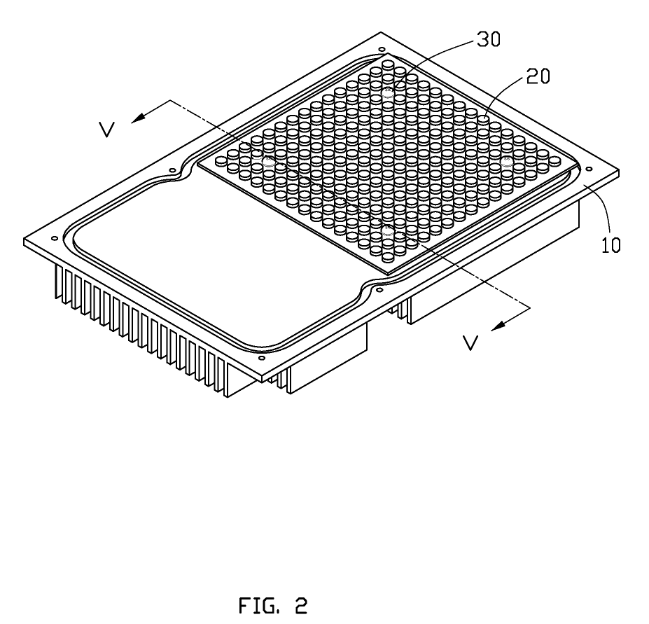

Referring to FIGS. 1-2, an LED lamp in accordance with a present embodiment is illustrated. The LED lamp comprises a heat sink 10, an LED module 20 located on the heat sink 10, and a mounting device (not labeled) for securing the LED module 20 on the heat sink 10. The mounting device includes four screws 30 extending through the LED module 20, and four elastic members 40 mounted on the screws 30 and positioned between the LED module 20 and the heat sink 10.

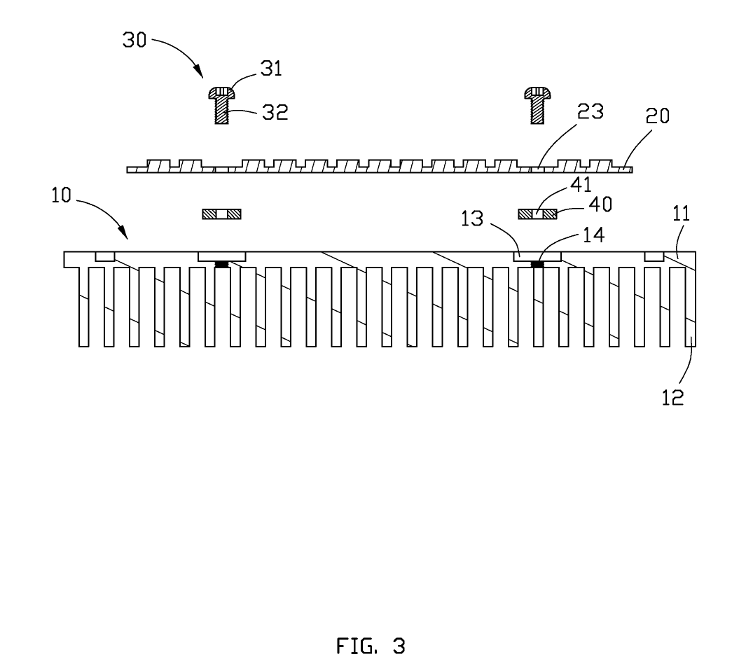

Also referring to FIG. 3, the heat sink 10 comprises a rectangular base 11 and a plurality of fins 12 extending downwardly from a bottom surface of the base 11. Four round recesses 13 are defined in a top surface of the base 11. A depth of the recesses 13 is smaller than a thickness of the base 11. A screw hole 14 is defined in a center of each of the recesses 13 and extends downwardly through the base 11.

The LED module 20 comprises a substantially square circuit board 21 and a plurality of LEDs 22 arranged on an upside (not labeled) of the circuit board 21 in matrix. Corresponding to the four screw holes 14 in the base 11, four through holes 23 are defined in the circuit board 21.

The screws 30 each comprise a cap 31 and a bolt 32 extending downwardly from the cap 31. Threads (not labeled) are formed on an outer surface of the bolt 32. A diameter of each of the bolts 32 is the same as (or slightly smaller than) that of each of the through holes 23 so that the bolts 32 of the screws 30 can extend through the through holes 23 of the LED module 20. The cap 31 has a diameter larger than that of the through hole 23; thus, the cap 31 can abut against the upside of circuit board 21 of the LED module 20.

The elastic member 40 is of an elastic material such as rubber. In this embodiment, each elastic member 40 is a rubber ring with a central hole 41 defined therein. A thickness of each elastic member 40 is similar to the depth of the recess 13 of the base 11 of the heat sink 10. An outer diameter of the elastic member 40 is smaller than that of the recess 13. In an originally natural shape, an inner diameter of each elastic member 40 (i.e., a diameter of the central hole 41) is smaller than that of the bolt 32 of the screw 30. The elastic member 40 can be elastically expanded in a radial direction when an expanding force in the radial direction is applied thereto, so that the bolts 32 of the screws 30 are able to engage in and extend through the central holes 41 of the elastic members 40, respectively.

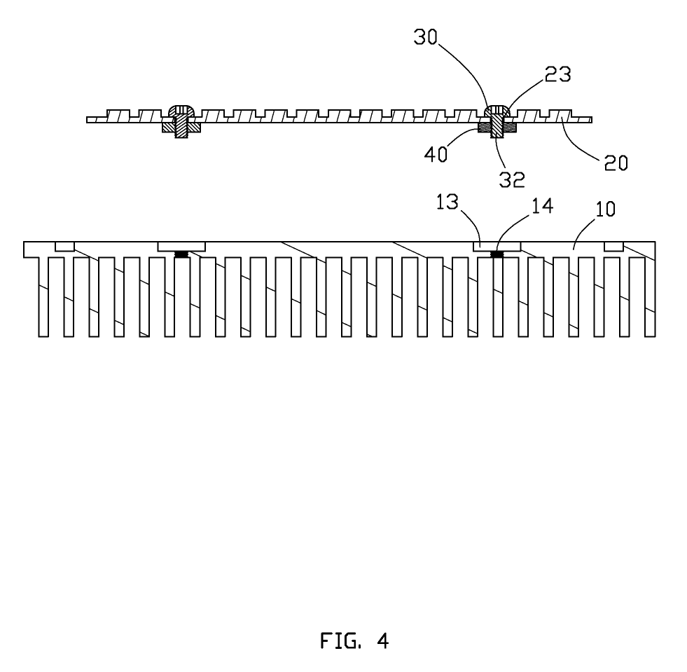

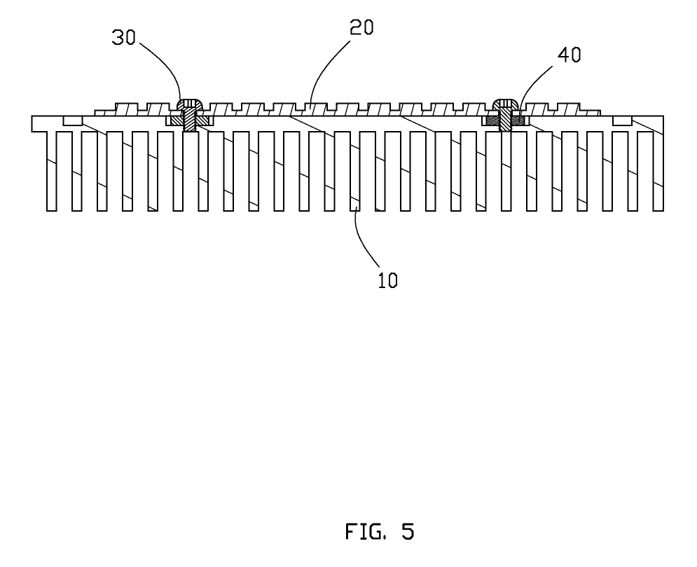

Please referring to FIGS. 4-5, in assembly of the LED lamp, the screws 30 extend through the through holes 23 of the LED module 20 until the caps 31 of the screws 30 are located on the upside of the circuit board 21 of the LED module 20; then the elastic members 40 are mounted to the bolts 32 of the screws 30 from a bottom side of the circuit board 21 until the bolts 32 extend into the central holes 41 of the elastic members 40 and the elastic members 40 abut against a downside (not shown) of the circuit board 21. The elastic members 40 are elastically expanded by the bolts 32 which are extended into the central holes 41 of the elastic members 40, whereby the elastic members 40 securely engage with the bolts 32 of the screws 30. Accordingly, the elastic members 40 and the screws 30 are connected together and the screws 30 are securely attached to the circuit board 21 of the LED module 20 by the elastic members 40. Therefore, the screws 30 are pre-assembled to the LED module 20 by the elastic members 40. The screws 30 are then brought to be threadedly engaged in the screw holes 14 of the heat sink 10, and the LED module 20 is accordingly secured on the base 11 of the heat sink 10. The elastic members 40 are received in the recesses 13 of the base 11.

The elastic members 40 can combine the screws 30 and the LED module 20 to prevent the screws 30 from dropping therefrom; thus, the assembly of the LED lamp is more convenient and simplified. In addition, if the LED module 20 is required to be replaced for maintenance or repair, another LED module with the screws 30 and the elastic members 40 pre-assembled thereon can be readily used to be screwed to the heat sink 10, without the necessity for finding suitable screws for the securing.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An LED lamp comprising:
an LED module;
a heat sink having a base on which the LED module is mounted;
a plurality of screws extending through the LED module and into the base of the heat sink to secure the LED module on the base of the heat sink; and
a plurality of elastic members mounted on the screws and positioned between the base and the LED module, wherein the plurality of screws also extends through the elastic members and the elastic members are expanded by the screws to resiliently engage with the screws.

2. The LED lamp as claimed in claim 1, wherein the elastic members are rubber rings.

3. The LED lamp as claimed in claim 1, wherein a plurality of recesses is defined in the base for receiving the elastic members therein.

4. The LED lamp as claimed in claim 3, wherein a screw hole is defined in each of the recesses for threadedly receiving a corresponding screw therein.

5. The LED lamp as claimed in claim 1, wherein the LED module comprises a circuit board and a plurality of LEDs arranged on the circuit board, and wherein a plurality of holes is defined in the circuit board for extension of the screws therethrough.

6. The LED lamp as claimed in claim 1, wherein the screws each comprises a cap and a bolt with threads formed on the bolt, the elastic members are mounted on the bolts of the screws.

7. The LED lamp as claimed in claim 6, wherein the elastic members each have a central hole, and the bolt of each screw extends through the central hole of a corresponding elastic member.

8. The LED lamp as claimed in claim 1, wherein the heat sink further having a plurality of fins extending from the base.

9. An LED lamp comprising:
an LED module comprising a circuit board and a plurality of LEDs arranged on the circuit board;
a heat sink;
a plurality of screws each comprising a cap abutting against a side of the circuit board, and a bolt extending through the LED module for threadedly engaging in the heat sink; and
a plurality of elastic members engaging with the bolts of the screws and abutting against another side of the circuit board to pre-assemble the screws to the LED module.

10. The LED lamp as claimed in claim 9, wherein each of the elastic members has a ring-shaped configuration.

11. The LED lamp as claimed in claim 10, wherein each of the elastic members has an inner diameter less than an outer diameter of the bolt of each of the screws when the elastic members are in an original shape.
